(19) United States
(12) Patent Application Publication
(10) Pub. No.: US 2025/0392668 A1
(43) Pub. Date: Dec. 25, 2025

(54) INFORMATION PROCESSING DEVICE, METHOD, AND PROGRAM

(71) Applicant: CANON KABUSHIKI KAISHA, Tokyo (JP)

(72) Inventor: MIGAKU YOSHIOKA, Kanagawa (JP)

(21) Appl. No.: 19/226,543

(22) Filed: Jun. 3, 2025

(30) Foreign Application Priority Data
Jun. 21, 2024 (JP) 2024-100302

(51) Int. Cl. H04N 1/00

(52) U.S. Cl. CPC H04N 1/00344; H04N 1/00244

(57) ABSTRACT

An apparatus relays communications between network devices and a device management server. The apparatus includes one or more memories storing instructions, and one or more processors capable of executing the instructions causing the apparatus to: acquire management information relating to the network devices; execute calculation processing to calculate a number of threads for the management information to be transmitted to the device management server in a multithread based on a number of the network devices with which communications are being relayed; execute adjustment processing to adjust a standby time for after the management information that has been transmitted to the device management server in a multithread based on a type of the management information and a data amount for the management information; and transmit the management information to the device management server in a multithread based on the calculated number of threads and the standby time.

### BACKGROUND

### Field of the Invention

The present invention relates to an information processing apparatus, a method, and a program.

### Description of the Related Art

In recent years, a device management system has been known that executes maintenance for network devices such as image forming apparatuses and the like that are installed in offices or the like via a network. By using such a device management system, it becomes possible to detect that an error has occurred in the network device, that it is necessary to refill the consumable products used by the network device, and the like, via a network, and to rapidly respond.

A system comprising a device management server, and a monitoring apparatus is known as a conventional device management system. The device management server unitarily controls each device. The monitoring apparatus operates as a management client that collects management information from a plurality of network devices, and transmits the management information to the device management server at the timing of when an error has occurred, a periodic timing, and the like.

However, in conventional device management systems, in cases in which the number of devices that are managed increases, and settings have been made such that data is transmitted at a particular time, such as outside of business hours, and the like, a plurality of monitoring apparatuses will simultaneously begin the transmission of data. Therefore, in conventional device management systems, it is assumed that the network burden for the environment in which the network devices have been installed, the burden due to server access, and the like will increase.

Japanese Unexamined Patent Application No. 2021-131774 discloses a server system that adds a standby time that has been calculated at random within a predetermined time from the transmission timing that has been set in a case in which a plurality of devices have been started up at the same time. The burden on the network for the environment in which these devices are installed, the burden due to access to the server, and the like are thereby suppressed in this server system. In addition, this server system is used in an environment in which there is not a large amount of data being transmitted for each device, and therefore, there is no need to take into consideration the transmission interval, the transmission time, and the like after the data transmission has begun.

However, in a management client in which a large volume of management information is collected from a large number of devices and transmitted to the management server, there are cases in which a large volume of management information is transmitted simultaneously over a short period of time at a periodic transmission timing. In such a case, the burden on the network for the environment in which the management client has been installed, the burden due to access to the sever, and the like, become high.

In this context, it becomes necessary for the management client to take time transmitting the data instead of simultaneously transmitting the data over a short period of time, and to suppress the number of requests at the peak reception time for the management server. In contrast, it is also necessary for the management client to avoid cases in which transmission of data takes too long, and the data transmission exceeds a specific time period such as the time outside of business hours, and the like.

In addition, there is also a possibility that the burden due to access to the management server, and the burden to the network for the environment in which the management client is installed will further increase due to the management client simultaneously transmitting data with a large size to the management server over a short period of time based on the timing at which the data is transmitted.

### SUMMARY

In this context, a goal of the present disclosure is to disperse the burden due to access to the management server by the management client and the burden to the network for the environment in which the client has been installed.

In order to solve the above-described problem, an information processing apparatus according to the present disclosure comprising: one or more memories storing instructions, and one or more processors capable of executing the instructions causing the information processing apparatus to: acquire management information that is information relating to the network devices; execute calculation processing to calculate a number of threads for the management information to be transmitted to the device management server in a multithread based on a number of the network devices with which communications are being relayed; execute adjustment processing to adjust a standby time for after the management information that has been transmitted to the device management server in a multithread based on a type of the management information and a data amount for the management information; and transmit the management information to the device management server in a multithread based on the number of threads calculated by the calculation processing and the standby time.

Further features of the present invention will become apparent from the following description of exemplary embodiments with reference to the attached drawings.

### BRIEF DESCRIPTION OF THE DRAWINGS

FIG. 1 is a diagram showing the entirety of a device management system according to a First Embodiment.

FIG. 2 is a block diagram showing an example of a hardware configuration for an image forming apparatus that functions as a network device according to the First Embodiment.

FIG. 3 is a block diagram showing an internal configuration of a monitoring apparatus and server according to the First Embodiment.

FIG. 4 is a block diagram showing an example of a functional configuration of an image forming apparatus that functions as a network device according to the First Embodiment.

FIG. 5 is a block diagram showing an example of a functional configuration of the monitoring apparatus according to the First Embodiment.

FIG. 6 is a diagram showing an example of a transmission schedule setting screen that is displayed by a screen control unit of the monitoring apparatus according to the First Embodiment.

FIG. 7 is a diagram showing an example of management information and transmission data for a device that is managed by a data management unit of the monitoring apparatus according to the First Embodiment.

FIG. 8 is a flowchart showing an example of processing for managing a number of threads that will be transmitted by a transmission unit of the monitoring apparatus according to the First Embodiment.

FIG. 9 is a flowchart showing an example of processing relating to a thread that will be transmitted by a transmission unit of the monitoring apparatus according to the First Embodiment.

### DESCRIPTION OF THE EMBODIMENTS

Below, modes for enabling the present disclosure will be explained by using embodiments and drawings. However, the present disclosure is not limited to the following embodiments. Note that in each figure, the parts and elements that are the same are given the same reference numerals. In addition, in the following embodiments, explanations of overlapping contents will be simplified or omitted.

### First Embodiment

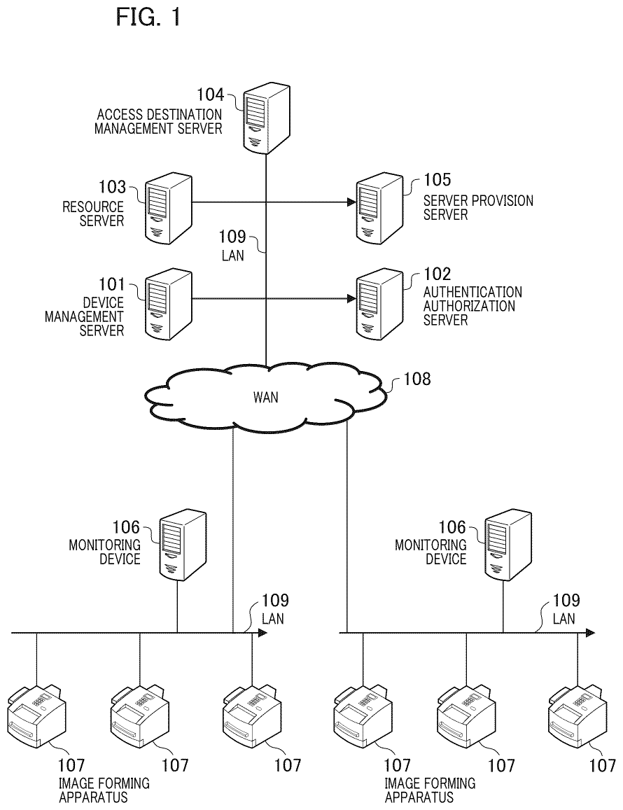

FIG. 1 is a diagram showing the entirety of a device management system according to the First Embodiment. The device management system according to the First Embodiment is a system that manages an image forming apparatus 107 (also referred to below as a device) as a network device. Note that the network device is not limited to an image forming apparatus, and may also be any type of device that can be connected to a network.

A device management server 101 manages information for the image forming apparatus 107 and a monitoring apparatus 106, which are targets for each type of service. An authentication authorization server 102 provides an authentication and authorization function for safely connecting the image forming apparatus 107 and the monitoring apparatus 106 to each type of server.

In the First Embodiment, a general OAuth structure is used, and each device (the image forming apparatus 107, the monitoring apparatus 106, and the like) is registered as a client that has been linked with a specific tenant. In this context, a tenant means a unit of management that is assigned to each customer who has entered into a usage contract for the service.

The authentication authorization server 102 manages data at the unit of a tenant. In addition, the authentication authorization server 102 issues tokens to the clients such as the image forming apparatus 107, the monitoring apparatus 106, and the like. Each device (the image forming apparatus 107, the monitoring apparatus 106, and the like) becomes able to access each type of server by using these tokens.

A resource server 103 manages information that has been collected from the image forming apparatus 107. This information becomes necessary primarily for the provision of the service to the image forming apparatus 107.

An access destination management server 104 provides URLs for the device management server 101, the resource server 103, and the like, which become the access destinations for each device, according to requests from each device (the image forming apparatus 107, the monitoring apparatus 106, and the like).

A service provision server 105 provides each type of service, such as a maintenance service, a reporting service, and the like, based on each type of information for the image forming apparatus 107 that is managed by the resource server 103. The service provision server 105 provides the user with a web user interface (Web UI: Web User Interface). It is thereby possible for the service provision server 105 to be able to set the information for each device (the image forming apparatus 107, the monitoring apparatus 106, and the like) that the user wishes to manage.

The information for each device that was set by the above-described web user interface can also be reflected on the device management server 101 and the resource server 103. Note that the server 101 to the server 105, the monitoring apparatus 106, and the image forming apparatus 107 are connected to a network (WAN (Wide Area network) 108, and a LAN (Local Area Network) 109).

The monitoring apparatus 106 is an example of an information processing apparatus that relays communications between a network device and the device management server 101 that manages the network device. A plurality of monitoring apparatuses 106 exist on the network, and these operate during the standard time zones for the regions thereof. In addition, the monitoring apparatus 106 may also monitor a plurality of separate image forming apparatus 107 that have been installed on one LAN 109.

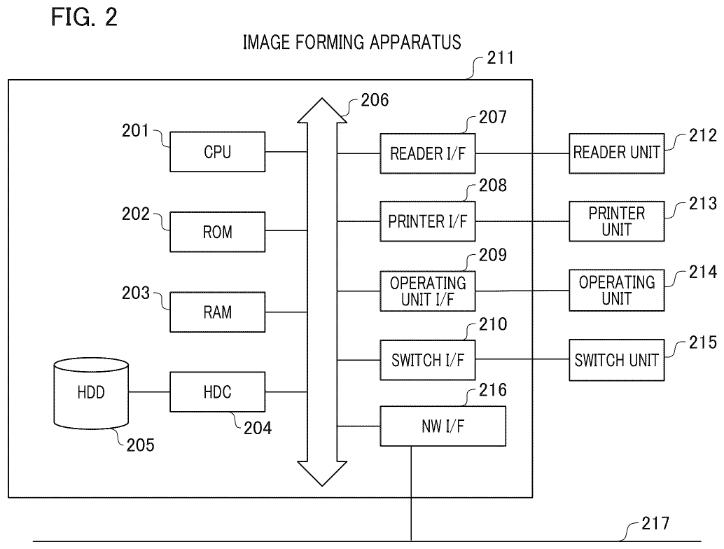

FIG. 2 is a block diagram showing an example of a hardware configuration for an image forming apparatus that serves as a network device according to the First Embodiment.

A CPU (central processing unit) 201 is stored on a ROM (Read Only memory) 202 and an HDD (Hard Disk Drive) 205, and executes a computer program that controls the entirety of the device, and integrally controls each device that is connected to the system bus 206. The RAM 203 functions as a work area and the like of the CPU 201. The HDC 204 is a hard disk controller that controls the HDD 205. A reader I/F 207 is connected to a reader unit 212, and controls this device. A printer I/F 208 is connected to a printer unit 213, and controls this device.

An operating unit I/F 209 is connected to an operating unit 214, and controls display to the operating unit 214, the user inputs that use the operating unit 214, and the like. The operating unit 214 is configured by a button for performing operations, a display unit, and the like. A switch I/F 210 is connected to a switch unit 215, and controls operations using the switch unit 215. The switch 215 is configured by a switch and the like for performing operations. The network I/F 216 transmits and receives data to and from external apparatuses such as a host computer and the like via the network 217.

An overall control unit 211 controls the operations for the entirety of the device together with controlling each type of apparatus, and the interfaces that have been connected to the image forming apparatus 107. The reader unit 212 functions as a scanner. The reader unit 212 reads an image of a document, and outputs image data to the printer unit 213 according to this image based on instructions from the user. Conversely, the reader unit 212 reads an image of a document, and stores image data corresponding to this image on the storage apparatus of the device based on an instruction from the user. In addition, the reader unit 212 is also able to transmit the above-described image data to a host computer that has been connected to the network 217 via a network I/F 216.

The printer unit 213 functions as a printer. The printer unit 213 prints image data based on a document that has been read by the reader unit 212, image data that has been stored on the HDD 205 that serves as a storage apparatus inside of the device body, and the like. In addition, the printer unit 213 receives print jobs from the host computer that has been connected to the network 217 via the network I/F 216, and prints image data relating to these print jobs. The network I/F 216 is connected to the printer unit 213 via the network 217, and is used by the overall control unit 211 in order to perform mutual communications between the other information devices on the network 217.

The operating unit 214 performs the display of information to the user using the overall control unit 211 and notifies the overall control unit 211 of inputs and the like by the user using a button, a display apparatus, a liquid crystal display screen with a touch panel or a combination thereof. The switch unit 215 controls the ON/OF state of the power source for the overall control unit 211.

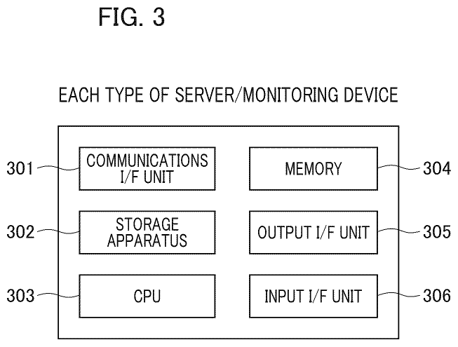

FIG. 3 is a block diagram showing an example of an internal configuration of the monitoring apparatus and a server according to the First Embodiment. A communications I/F unit 301 is a network interface for executing communications with external systems and external apparatuses. A storage apparatus 302 stores an OS (Operating System) and computer program, management data, data that has been collected from external systems and apparatuses, and the like. A CPU 303 that serves as a computer loads a computer program from the storage apparatus 302 onto a memory 304 and executes it. An output I/F unit 305 is connected to an output apparatus such as a display and the like and outputs the results of executing the computer program and the like. An input I/F unit 306 is connected to a keyboard and pointing device, and the like, and receives an operation input from the user.

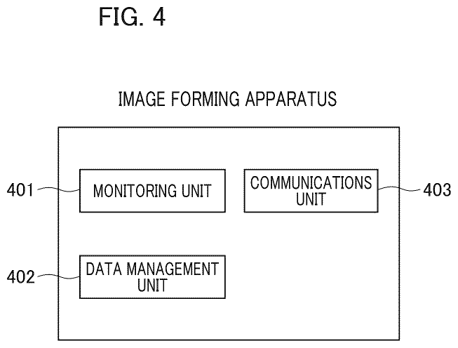

FIG. 4 is a block diagram showing an example of a functional configuration of an image forming apparatus that serves as a network device according to the First Embodiment. A monitoring unit 401 executes the collection of data necessary for performing monitoring, and the like. A data management unit 402 manages the data that is collected by the monitoring apparatus 106. A communications unit 403 transmits the data that has been collected by the monitoring unit 401 according to requests from the monitoring apparatus 106.

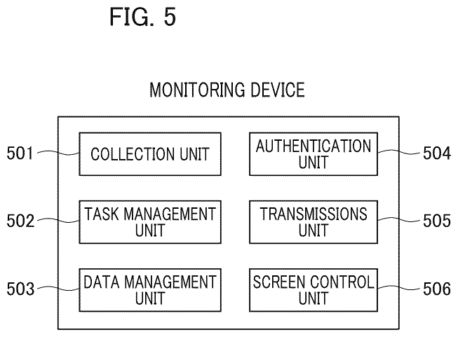

FIG. 5 is a block diagram showing an example of a functional configuration of a monitoring apparatus according to the First Embodiment. The explanation using FIG. 5 will focus on one from among a plurality of monitoring apparatuses.

A collection unit 501 is an example of an acquisition unit that acquires management information, which is information relating to a network device. The collection unit 501 executes communications with the image forming apparatus 107, and collects the data necessary for monitoring.

A task management unit 502 executes tasks to acquire a list of devices that have been registered in advance as management targets of the monitoring apparatus 106 (referred to below as a management target device list) from the device management server 101, monitoring tasks to collect data from a device using the collection unit 501, and the like. In addition, the task management unit 502 also manages each type of task such as the registration of the monitoring apparatus 106 and the image forming apparatus 107, and the like. Therefore, the task management unit 502 is one example of a registration unit that executes registration processing to register a network device as a target of management by the device management server 101.

During self-registration of the monitoring apparatus 106, the monitoring apparatus 106 acquires a token by registering itself to the authentication authorization server 102, and acquires URLs for each type of server from the access destination management server 104 using this token. In addition, communications tests are executed for each type of server during the self-registration of the monitoring apparatus 106.

A data management unit 503 is an example of a calculation unit that executes calculation processing to calculate a number of threads for management information that is transmitted to the device management server 101 in a multithread based on the number of network devices with which communications are being relayed. For example, the data management unit 503 also manages the largest number of threads that are transmitted at the same time in a transmission unit 505 according to the number of management target devices that have been registered, in addition to managing the management information and the like that has been collected from the image forming apparatus 107, and the device information that is necessary for monitoring. In addition, the device management unit 503 may also execute calculation processing each time that the above-described registration processing is completed.

An authentication unit 504 executes communications with the authentication authorization server 102, and executes registration processing, token acquisition, management, and the like for the monitoring apparatus 106 and the image forming apparatus 107.

The transmission unit 505 is one example of an adjustment unit that executes adjustment processing to adjust the standby time for after management information has been transmitted to the device management server 101 in a multithread based on the type of management information and the data amount for the management information. In addition, the transmission unit 505 is an example of a transmission unit that transmits management information to the device management server 101 in a multithread based on a number of threads that has been calculated by the calculation unit and a standby time that has been adjusted by the adjustment unit. For example, the transmission unit 505 transmits the management information and the like that has been collected from the image forming apparatus 107, and the data necessary for monitoring to the resource server 103.

A screen control unit 506 displays an image on an output apparatus via the output I/F unit 305, and stores input information from an input apparatus via the input I/F 306 on the data management unit 503.

Note that each functional block that has been shown in FIG. 4 and each functional block that has been shown in FIG. 5 are realized by the CPU and the like that serves as a computer and is included in each apparatus executing a computer program that has been stored on a memory that serves as a storage medium. However, at least a portion of each functional block that has been shown in FIG. 4 and at least a portion of each functional block that has been shown in FIG. 5 may also be realized using hardware. For example, a dedicated circuit such as an ASIC (Application Specific Integrated Circuit) and the like, a processor such as a digital signal processor (DSP), and the like are given as examples of such hardware.

In addition, each functional block that was shown in FIG. 4 may also be housed inside of one body, or they may also be separated and housed in a plurality of bodies. In the same manner, each functional block that has been shown in FIG. 5 may also be housed inside of one body, or they may also be separated and housed in a plurality of bodies.

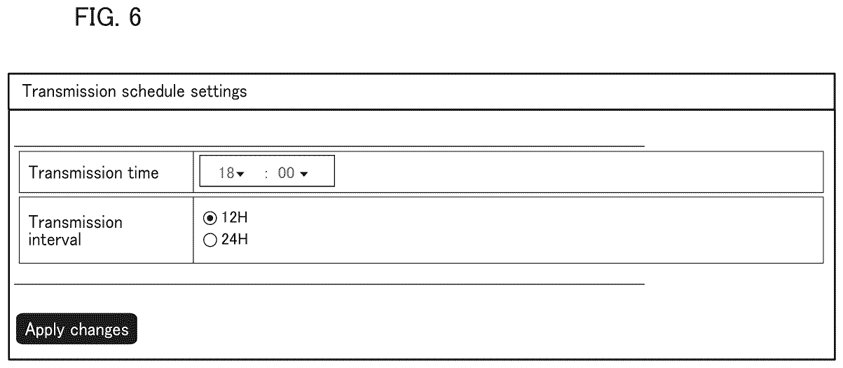

FIG. 6 is a diagram showing an example of a transmission schedule setting screen that is displayed by the screen control unit of the monitoring apparatus according to the First Embodiment. The monitoring apparatus 106 executes periodic transmissions using the transmission unit 505 based on settings that have been input on the transmission schedule setting screen.

A “transmission time” section has a time input form for setting a time at which the transmission unit 505 will begin periodic transmissions.

The default time for the “transmission time” section is set at random from among nighttime time periods that generally fall outside of business hours.

The monitoring apparatus 106 may also be provided with a storage unit that stores information relating to management information that has been transmitted by the transmission unit. The storage unit adds a date and time of the next transmission of management information to the standby time that has been determined at random for each type of management information and network device, and stores this.

The time input form for the “transmission time” section makes it possible to set the transmission time in units of 30 minutes. In addition, the time at which the transmission actually begins becomes a time that has been internally calculated at random from between 0 to 29 minutes from the time that is displayed on the screen. For example, the time at which the transmission is actually started becomes one of the times between 18:30 and 18:59 in a case in which the default time is 18:30.

A “transmission interval” section has a radio button for setting an interval at which periodic transmission is executed by the transmission unit 505. In a case in which “12H” has been selected using the radio button, twice a day transmission is executed, once at the transmission start time that has been set using the “transmission time” section, and once at a time in which 12 hours has been added to this transmission start time. In a case in which “24H” has been selected using the radio button, once a day transmission is executed, only at the transmission start time that has been set using the “transmission time” section.

Next, by pressing down an “apply changes” button, it is possible to confirm the transmission schedule settings and store the transmission schedule settings to the data management unit 503.

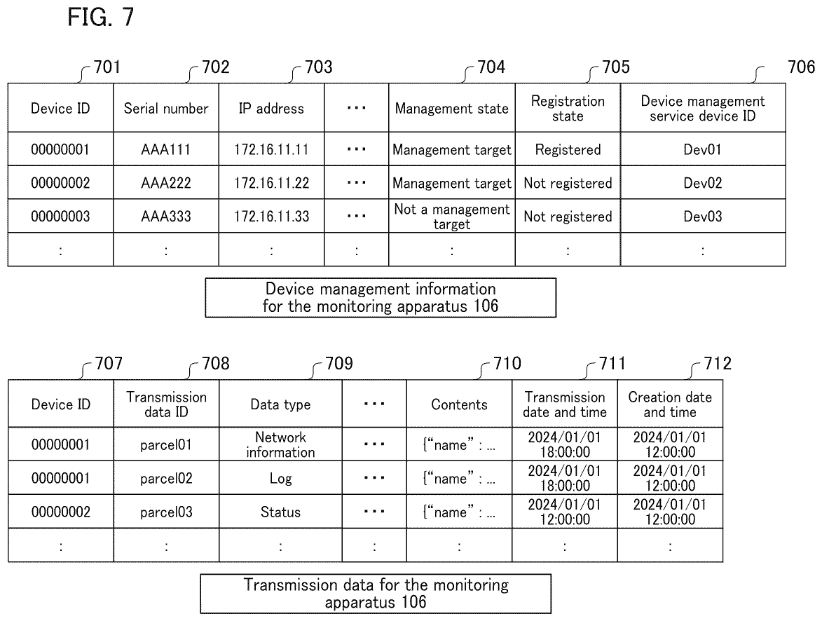

FIG. 7 is a diagram showing an example of management information and transmission data for a device that is managed by the data management unit of the monitoring apparatus according to the First Embodiment. The transmission data has information relating to the data transmissions that have been collected from the device by the collection unit 501 from among the monitoring tasks that are periodically executed by the task management unit 502 added thereto, and is data that is stored on the data management unit 503. FIG. 7 shows a column 701 to a column 712.

Column 701 and Column 707 show device IDs, which are information that uniquely identifies a device within the monitoring apparatus 106. Column 702 shows a serial number, which is information that uniquely identifies a device. Column 703 shows an IP address for a device. Note that in this context, although an IP address is given as an example of information for accessing a device, this may also be a host name, a URL, and the like instead of an IP address.

Column 704 shows a management state that shows whether or not a device is a management target of the device management system. Column 705 shows a registration state that shows whether or not an image forming apparatus that is a management target of the device management system has been normally registered. Column 706 shows a device management service device ID for the device management server 101 to uniquely identify the image forming apparatus 107. Note that the information for the device management server 101 to uniquely identify the image forming apparatus 107 is not limited to a device management service device ID.

Column 708 shows a transmission data ID for uniquely identifying transmission data within the monitoring apparatus 106. The column 709 shows a data type that shows a data classification of the transmission data. During a monitoring task that is executed by the task management unit 502, when data is acquired from the device and stored to the data management unit 503, the type of the data that has been acquired is stored. Column 710 shows contents that show the contents of the data that is transmitted to the resource server 103. The data that has been collected from the device through the collection unit 501 by the task management unit 502 is converted to a JSON format for transmission to the resource server 103, and stored as the contents 710.

The column 711 shows a transmission date and time that shows the transmission date and time for the transmission data. When the transmission date and time for transmission data is stored in the data management unit 503, the next transmission date and time that has been set on the transmission schedule setting screen is calculated. The transmission unit 505 periodically confirms if the current time has passed the transmission date and time 711, and in a case in which the current time has passed transmission date and time, begins the transmission processing. In this context, in a case in which the data type 709 is a type of data that should be transmitted to the resource server immediately, such as a device status, error information, and the like, the task management unit 502 makes the transmission date and time 711 in the monitoring task the current time and stores this. The creation date and time 712 is information showing the date and time at which transmission data was created in the task management unit 502.

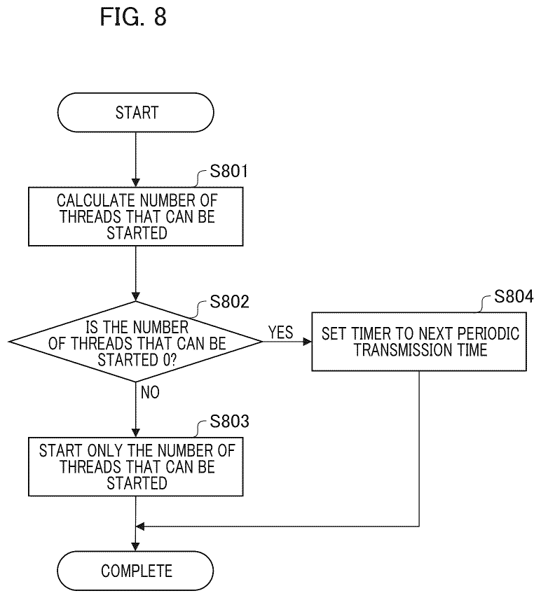

FIG. 8 is a flowchart showing an example of processing to manage a plurality of threads that are transmitted by the transmission unit of the monitoring apparatus according to the First Embodiment. As will be explained below, during the processing that is shown in FIG. 8, in a case in which there is data that needs to be transmitted, processing is begun for threads until the number of threads becomes the maximum number of threads. In addition, the processing that is shown in FIG. 8 may be executed periodically by the transmission unit 505, it may also be executed when a monitoring task has been completed by the task management unit 502, or it may also be executed at an arbitrary timing based on operations of the screen control unit 506 by the user.

During step S801, the transmission unit 505 calculates the number of threads that can be started. Specifically, during step S801, the transmission unit 505 compares the difference between the greatest number of threads and the current number of threads with the number of transmission data for which the transmission time has been passed, and defines the smaller number of threads as the number threads that can be started.

The greatest number of threads is set to be larger the larger the total number of devices is for the devices for which the column 704 in FIG. 7 is set as “management target”, and the column 705 is set at “registered”. In addition, the timing at which the greatest number of threads is set may be the timing at which the registration task for the image forming apparatus 107 that is periodically executed by the task management unit 502 is completed, or it may also be a timing that has been periodically set by the transmission unit 505.

In this context, the transmission unit 505 sets the maximum number of threads to be larger the larger the number of devices being monitored by the monitoring apparatus 106 is, and sets the maximum number of threads to be smaller the smaller the number of devices being monitored by the monitoring apparatus 106 is. It is thereby possible for the transmission unit 505 to prevent the transmission time from becoming too long in monitoring devices 106 for which the number of devices being monitored is large. It is thereby also possible for the transmission unit 505 to lessen the burden due to the monitoring apparatus 106 accessing the resource server 103 and the burden on the network for the environment in which the monitoring apparatus 106 has been installed.

For example, in a case in which the number of devices that are being monitored by the monitoring apparatus 106 is 600 or more, the transmission unit 505 sets the greatest number of threads to “10”. In addition, for example, in a case in which the number of devices that are being monitored by the monitoring apparatus 106 is 300 to 599, the transmission unit 505 sets the greatest number of threads to “6”. In addition, for example, in a case in which the number of devices that are being monitored by the monitoring apparatus 106 is 299 or less, the transmission unit 505 sets the greatest number of threads to “3”.

During step S802, the transmission unit 505 determines whether or not the number of threads that can be started that was calculated during step S801 is “0”. In a case in which the transmission unit 505 has determined that the number of threads that can be started that was calculated during step S801 is “0” (Step S802: Yes), the processing proceeds to step S804. In contrast, in a case in which the transmission unit 505 has determined that the number of threads that can be started that was determined during step S801 is not “0” (Step S802: No), the processing proceeds to step S803.

During step S803, the transmission unit 505 starts exactly the number of threads that can be started that was calculated during step S801.

During step S804, the transmission unit 505 sets a timer such that the processing for FIG. 8 will be started at the next transmission date and time that was set on the transmission schedule setting screen.

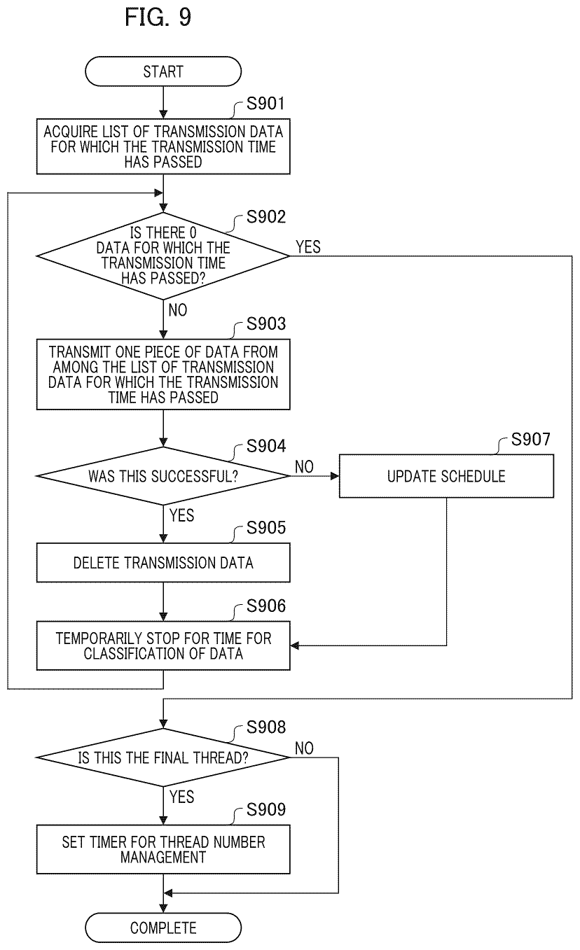

In a case in which the type of the management information that was transmitted by the transmission unit corresponds to a specific type, the information processing apparatus may temporarily stop the operations after transmission of the management information by the transmission unit. FIG. 9 is flowchart showing an example of processing relating to threads that are transmitted by the transmission unit of the monitoring apparatus according to the First Embodiment. As will be explained below, during the processing in FIG. 9, the data for which the transmission time has been passed is transmitted, and the processing for the threads is temporarily stopped according to the classification of each data type. In addition, the processing that is shown in FIG. 9 is started in a case in which it has been determined by the processing that is shown in FIG. 8 that the thread processing can be started.

During step S901, the transmission unit 505 acquires data for which the transmission time has been passed from the data management unit 503. Specifically, during step S901, the transmission unit 505 acquires the device ID and data type for the transmissions data having the oldest creation date and time 712, and acquires all of the transmission data having the same device ID and data type in the order of the oldest creation date and time 712.

The data that has been acquired in this context is managed by the transmission unit 505 as data that is currently being transmitted. When the transmission data for a different thread is acquired during step S901, the transmission data that is being managed as data that is currently being transmitted is excluded from the transmission data.

During step S902, the transmission unit 505 determines whether or not the number of pieces of transmission data that were acquired during step S901 is “0”. In a case in which the transmission unit 505 has determined that the number of pieces of transmission data that were acquired during step S901 is “0” (Step S902: Yes), the processing proceeds to step S908. In contrast, in a case in which the transmission unit 505 has determined that the number of pieces of transmissions data that were acquired during step S901 was not “0” (Step S901: No), the processing proceeds to step S903.

During step S903, the transmission unit 505 transmits, from among the transmission data that was acquired during step S901, the one piece pf data having the oldest creation date and time as shown in column 712 of FIG. 7, to the resource server 103.

During step S904, the transmission unit 505 determines whether or not the transmission during step S903 was successful. In a case which the transmission unit 505 has determined that the transmission during step S903 was successful (step S904: Yes), the processing proceeds to step S905. In contrast, in a case in which the transmission unit 505 has determined that the transmission during step S903 was not successful (Step S904: No), the processing proceeds to step S907.

During step S905, the transmission unit 505 deletes the data for which the transmission has been completed from the data management unit 503. During step S905, the transmission unit 505 also deletes the data for which the transmission has been completed from the data that is currently being transmitted.

During step S906, the transmission unit 505 temporarily stops the thread processing according to the classification of the data type 709 for the data for which the transmission has been completed. In addition, in this context, the larger the size of the data is for the data type, the longer the transmission unit 505 makes the time for which the thread processing will be temporarily stopped. The transmission unit 505 thereby lessens the burden due to access to the resource server 103, the burden to the network on which the monitoring apparatus 106 is installed, the burden on the CPU 303 that is installed in the monitoring apparatus 106, and the like.

The counter information including the number of prints, the number of copies, and the like has a comparatively large volume, and therefore, the thread processing is stopped for 6 seconds. The counter information including the consumable products has the next largest volume after the counter information including the number of prints, the number of copies, and the like, and therefore the thread processing is stopped for 4 seconds. The volume for the counter information including the environmental information such as the temperature, humidity, and the like, the network information, and the like has a comparatively small volume, and therefore, the thread processing is stopped for 2 seconds.

It is thereby possible to provide an interval within this thread before the next transmission by step S903. In addition, in a case in which a transmission is the final transmission within a thread, the number of threads during the stopping of this thread is taken up by one thread, and therefore, it is possible to provide an interval in the time until the this thread is finished and the next thread is started, and the transmission intervals are adjusted according to the data type.

During step S907, the transmission unit 505 updates the transmission date and time displayed in the column 711 shown in FIG. 7 for data for which the transmission has failed, and deletes data for which the transmission has failed from the data that is currently being transmitted that is managed by the transmission unit 505. In this context, the transmission date and time that is updated may be the next transmission date and time that has been set on the transmission schedule setting screen, or it may also be a date and time in which several minutes have been added to the current time for the transmission retry. Conversely, in this context, the transmission date and time that is updated may also be the next transmission date and time that was set on the transmission schedule setting screen and a date and time to which several minutes have been added for the transmission retry have been added to the current time according to the classification of the data type 709.

During step S908, the transmission unit 505 calculates the number of threads that are currently being executed, and determines whether or not there are any other threads being executed. In a case in which the transmission unit 505 has determined that there are other threads being executed (step S908: Yes), the processing proceeds to step S908. In contrast, in a case in which the transmission unit 505 has determined that there are no other threads being executed (step S908: No), the processing is completed.

During step S909, the transmission unit 505 sets a timer such that the management processing that was shown in FIG. 8 will begin immediately.

By executing the processing that is shown in FIG. 9, the transmissions time for monitoring devices 106 that are monitoring a large number of devices no longer takes too long. In addition, by executing the processing that was shown in FIG. 9, It is possible to disperse the burden due to access to the resource server 103 by the monitoring apparatus 106, and the burden on the network on which the monitoring apparatus 106 is installed.

### Second Embodiment

In the First Embodiment, when the transmission date and time that was set on the transmission schedule setting screen arrives, the processing is begun simultaneously for each thread of the exact number of the greatest number of threads.

In such a case, beginning the transmissions simultaneously is linked to a burden on the network for the environment in which the monitoring apparatus 106 has been installed. In addition, in a case in which a plurality of monitoring apparatuses 106 with overlapping transmission date and times exists, the number of pieces of transmission data directly after the transmission start increases, and this is linked to a burden due to access to the resource server 103.

The Second Embodiment is configured such that even in the above-described case, the burden on the network of the environment in which the monitoring apparatus 106 has been installed and the burden due to access to the resource server 103 are lessened.

Below, the Second Embodiment of the present disclosure will be explained. Note that in the description of the Second Embodiment, explanations relating to configurations that are the same as the configurations in the First Embodiment will be omitted.

In the Second Embodiment, when the transmission date and time that is shown in column 711 of FIG. 7 is saved to the data management unit 503, the next transmission date and time that was set on the transmission schedule setting screen is not saved. In the Second Embodiment, when the transmission date and time that is shown in column 711 of FIG. 7 is saved to the data management unit 503, the next transmission date and time that has been set on the transmission schedule setting screen is saved after a random standby time has been added thereto for each of the device IDs that are displayed in column 707 of FIG. 7 and the device types that are displayed in column 709 of FIG. 7.

According to the above processing, it is made such that each thread is not simultaneously started up directly after the periodic transmission has been started, and it is possible to disperse the burden caused by the monitoring apparatus 106 accessing the resource server 103, and the burden to the network for the environment in which the monitoring apparatus 106 has been installed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-100302, filed Jun. 21, 2024, which is hereby incorporated by reference herein in its entirety.

1. An information processing apparatus that relays communications between network devices and a device management server that manages the network devices, the information processing apparatus comprising:
one or more memories storing instructions, and
one or more processors capable of executing the instructions causing the information processing apparatus to:
acquire management information that is information relating to the network devices;
execute calculation processing to calculate a number of threads for the management information to be transmitted to the device management server in a multithread based on a number of the network devices with which communications are being relayed;
execute adjustment processing to adjust a standby time for after the management information that has been transmitted to the device management server in a multithread based on a type of the management information and a data amount for the management information; and
transmit the management information to the device management server in a multithread based on the number of threads calculated by the calculation processing and the standby time.

2. The information processing apparatus according to claim 1, wherein the instructions further cause the information processing apparatus to
execute registration processing to register the network devices as targets of management by the device management server; and
wherein the calculation processing is executed each time that the registration processing is completed.

3. The information processing apparatus according to claim 1, wherein, after a transmission of the management information, operations of a thread for the transmission is temporarily stopped in a case in which a type of the management information corresponds to a specific type of management information.

4. The information processing apparatus according to claim 1, the information processing apparatus further comprising:
a storage,
wherein the storage is configured to store:
information relating to the management information that has been transmitted to the device management server, and
transmission time calculated by adding a standby time determined randomly per type of the management information and per the network devices to a date and time at which the management information will be next transmitted.

5. A method for controlling an information processing apparatus that relays communications between network devices and a device management server that manages the network devices, the method comprising:
acquiring management information that is information relating to the network devices;
executing calculation processing to calculate a number of threads for the management information to be transmitted to the device management server in a multithread based on a number of the network devices with which communications are being relayed;
executing adjustment processing to adjust a standby time for after the management information has been transmitted to the device management server in a multithread based on a type of the management information and a data amount for the management information; and
transmitting the management information to the device management server in a multithread based on the number of threads calculated by the calculation processing and the standby time.

6. A non-transitory computer readable storage medium on which is stored a computer program for making a computer execute a method for an information processing device that relays communications between network devices and a device management server that manages the network devices, the method comprising:
acquiring management information that is information relating to the network devices;
executing calculation processing to calculate a number of threads for the management information to be transmitted to the device management server in a multithread based on a number of the network devices with which communications are being relayed;
executing adjustment processing to adjust a standby time for after the management information has been transmitted to the device management server in a multithread based on a type of the management information and a data amount for the management information; and
transmitting the management information to the device management server in a multithread based on the number of threads calculated by the calculation processing and the standby time.

7. The information processing apparatus according to claim 2, wherein, after a transmission of the management information, operations of a thread for the transmission is temporarily stopped in a case in which a type of the management information corresponds to a specific type of management information.

8. The information processing apparatus according to claim 2, the information processing apparatus further comprising:
a storage,
wherein the storage is configured to store:
information relating to the management information that has been transmitted to the device management server, and
transmission time calculated by adding a standby time determined randomly per type of the management information and per the network devices to a date and time at which the management information will be next transmitted.
